(19) United States
(12) Patent Application Publication
(10) Pub. No.: US 2010/0185428 A1
(43) Pub. Date: Jul. 22, 2010

(54) METHOD AND SYSTEM FOR SIMULATING FLUID FLOW IN AN UNDERGROUND FORMATION WITH UNCERTAIN PROPERTIES

(76) Inventor: Jeroen Cornelis VINK, GS Rijswijk (NL)

Correspondence Address: SHELL OIL COMPANY, P O BOX 2463, HOUSTON, TX, 772522463, US

(21) Appl. No.: 12/650,205

(22) Filed: Dec. 30, 2009

(30) Foreign Application Priority Data
Dec. 31, 2008 (EP) 08173143.2

(51) Int. Cl. G06G 7/50

(52) U.S. Cl. 703/10

(57) ABSTRACT

A method for simulating fluid flow in an underground reservoir formation with uncertain properties comprises: a) building an object oriented reservoir simulation model with embedded uncertainty descriptors for the uncertain properties; b) using the uncertainty descriptors to define probability distributions and parameterizations for data objects associated with the uncertain properties; c) providing each uncertainty descriptor with functionality to display a probability distribution to associated parameterized data objects to a user; and d) processing the reservoir simulation model in a reservoir flow simulator with a graphical user interface, which displays user selected uncertainty descriptors, parameterized data objects and/or resulting spread of reservoir flow simulation results.

### RELATED CASES

The present application claims priority from European Patent Application 08173143.2, filed 31 Dec. 2008.

### FIELD OF THE INVENTION

The invention relates to a method and system for simulating fluid flow in an underground formation with uncertain properties, such as an underground reservoir formation with one or more hydrocarbon fluid bearing layers with uncertain thicknesses, permeabilities, fractures and/or other physical properties.

### BACKGROUND OF THE INVENTION

U.S. Pat. No. 7,277,836 discloses a computer system and method for simulating transport phenomena in a complex system, such as a subterranean hydrocarbon-bearing formation. It is generally known that input data for reservoir flow simulations are often uncertain.

It also known how to include the effect of these uncertainties in reservoir simulation results. This is typically done by performing multiple simulations for a wide range of uncertain data. Widely used techniques include Experimental Design, Markov Chain Monte Carlo or ad hoc methods. In these workflows the uncertainty description for the input data is given separately from the data and invisible in the reservoir model.

### SUMMARY OF THE INVENTION

It is an object of the present invention to provide a reservoir simulation method and system in which uncertainty description is directly linked with the available uncertain reservoir data and visible in the reservoir model.

It is a further object of the present invention to provide an improved uncertainty description which is embedded in the simulation model and is an integral part of the input data and which shows how uncertainty embedded in the input data results in consequential uncertainty in the resulting reservoir flow simulation results and/or other output data in a user friendly, efficient and effective manner.

In accordance with the invention there is provided a method for simulating fluid flow in an underground reservoir formation with uncertain properties, the method comprising:

a) building an object-oriented reservoir simulation model with embedded uncertainty descriptors that describe a range of estimated values of each of the uncertain properties;

b) using the uncertainty descriptors to define probability distributions and parameterizations for data objects associated with the uncertain properties;

c) providing each uncertainty descriptor with functionality to display a probability distribution to an associated parameterized data object to a graphical user interface of a reservoir flow simulator; and

d) processing the reservoir simulation model in the reservoir flow simulator such that the graphical user interface displays user selected uncertainty descriptors, parameterized data objects and resulting spread of reservoir flow simulation results.

The method according to the invention may be used to plan, simulate, monitor, execute and/or manage hydrocarbon fluid operations from a hydrocarbon fluid containing reservoir formation and/or to plan, simulate, monitor, execute and/or fluid injection operations for stimulating production of hydrocarbon fluids therefrom.

In accordance with the invention there is further provided a system for simulating fluid flow in an underground formation comprising a number of hydrocarbon fluid containing layers with uncertain thicknesses, volumes, permeabilities and/or other physical properties, the system comprising:

a) a simulation model for the formation, which model represents the formation as a number of hydrocarbon fluid layers with predetermined base-case permeabilities, volumes, thicknesses and/or other physical input properties;

b) means for defining uncertainty descriptors for the uncertain properties;

c) means for specifying a statistical method for sampling the uncertain properties in the simulation model; and

d) display means for displaying the uncertainty descriptors and resulting spread of reservoir fluid flow simulation results in the simulation model.

Preferably the display means comprise means for displaying the uncertainty of the base case permeability and thickness and/or any other input data and/or for displaying the resulting spread of the simulated fluid flow and/or any other output data and/or means for displaying any spread of the simulated fluid flow and/or any other output resulting from uncertain input data with error bars, using a post-processing native to a worker tool.

These and other features, embodiments and advantages of the method and/or system according to the invention are described in the accompanying claims, abstract and the following detailed description of preferred embodiments disclosed in the accompanying drawings in which reference numerals are used which refer to corresponding reference numerals that are shown in the drawings.

### BRIEF DESCRIPTION OF THE DRAWINGS

For a more detailed understanding of the invention, reference is made to the accompanying Figures, wherein:

FIG. 1 shows a screenshot of a MoReS application in Dynamo reservoir simulator; and

FIG. 2 is a schematic layout of an object oriented data model with extensions to capture data uncertainty.

### DETAILED DESCRIPTION OF THE DEPICTED EMBODIMENTS

The present invention is based on the insight that all input data for reservoir flow simulations are uncertain to some extent. It is therefore important to include the effect of these uncertainties in reservoir simulation results.

In accordance with the present invention this is accomplished by embedding the uncertainty description in the simulation model thereby making it an integral part of the input data. This is achieved by allowing all data objects to link to an “uncertainty model” that describes the details of the variability (uncertainty ranges, probabilities etc) of that data. Also simulation output data now naturally is linked to uncertainty models that explicitly show the uncertainty (“error bars”) of the simulation results. Besides describing data uncertainty, this approach can also be used to describe “data controllability”: ranges and options for managing wells or other model controls that can be employed to optimize field development plans.

The following detailed description of a preferred embodiment of the method according to the invention indicates how this paradigm has been implemented in a modelling reservoir simulation platform, known as Dynamo, for upscaling, flow simulation and facility modelling. Reservoir simulation faces competing challenges. It may be required to simulate complex reservoirs that may be compartmentalized and faulted, in high-cost environments and/or with difficult fluids such as ultra-heavy oils.

On the one hand this requires time-consuming simulations that capture more detail and physics (both in the rock and geometry and in the fluids).

On the other hand, many of the subsurface properties are (very) uncertain and field development plans must take this into account and still be robust and optimal—which requires performing many simulations. A typical approach to capture the “model uncertainties” is to perform a (large) number of simulation runs and use the spread of results to assess the impact of input data uncertainty. When also field production or 4D seismic data is available, this data can be used to reduce the ranges of data uncertainty. In the last decade or so, a number of workflows have been developed that allow reservoir engineers in asset teams to produce field development plans which qualitatively of quantitatively take data uncertainty into account. These workflows use techniques like Markov Chain Monte Carlo sampling, Experimental Design and/or (ensemble) Kalman filters. It is a very active field of research to find new methods, or hybrids of the above.

Uncertainty managing workflows therefore required that many simulation runs are performed and analyzed and the task of handling the simulation input data and results may quickly become overwhelming. Hence, from a practical point of view, it is important to have a simulation platform that makes these workflows easy to perform for a broad range of reservoir engineers, and is flexible enough to quickly incorporate and rollout new approaches.

The following description of a preferred embodiment is based on the implementation in Shell's proprietary reservoir modelling platform, known as Dynamo. This is a simulation system that offers upscaling (Reduce++), reservoir flow simulation (MoReS) and surface facility modeling (PTNet) in an integrated and uniform way. The names in brackets are the names of the individual tool components in Dynamo. The Dynamo simulation programs have been developed in the early nineties and at that time were the only “interactive” simulation tools, Dynamo is described in SPE paper 19807 “A Fractured Reservoir Simulator Capable of Modeling Block-Block Interaction”, presented by G. J. Por et al at the 64^{th} Annual Technical Conference and Exhibition of the Society of Petroleum Engineers held in San Antonio, Tex., Oct. 8-11, 1969. The interactive Dynamo tools comprise an object oriented data model (written in C++), an embedded scripting language and a graphical user interface that gives uses full and interactive access to the simulation input and output data. In this description it is indicated that an integrated approach where data uncertainty is embedded in the reservoir model and where the workflow run manager is a component in the simulation system has a number of advantages over current approaches where the workflow manager is a separate tool and where data uncertainty is managed by that tool, separate from the simulation models(s).

The following detailed description of a preferred embodiment of the method and system according to the invention comprises the following sections:

A) some of the features of the Dynamo architecture;

B) the data organization and design ideas of integrated, embedded uncertainty managing;

C) an example of a simple uncertainty workflow; and

D) conclusions.

### A. Integrated Simulation System in Dynamo Architecture.

In order to explain the idea of embedded or integrated uncertainty modelling, it is relevant to describe certain features of the architecture of Dynamo. Dynamo is a software platform for dynamic subsurface simulations; it has a component (or “application”) for upscaling (coarsening the high-resolution rock-properties model that the geologists produced to a size and resolution manageable by the flow simulator; the name of this application in Dynamo is Reduce++), flow simulation (solving the hydrocarbon and water displacement in the subsurface model as a result of adding injection and production wells, the name of this application in Dynamo is MoReS) and for facility modelling (solving the flow through the surface pipeline, compression and separation network, honouring the throughput and other constraints on the maximum allowed flow; the name of this application in Dynamo is PTNet). The data model is object oriented, which makes it possible to implement all shared or common functionality in base-classes, which are part of the encompassing Dynamo application. Examples of these data types are tables, arrays (e.g. for grid properties) and scalar variables. Also plotting, 3D visualization and an embedded scripting interface to the application data is implemented as shared functionality in Dynamo and inherited by the three applications mentioned above. All user data in Dynamo (and hence in its components) is registered in a so-called object space. This object space in essence is a list with all core data objects (tables, arrays, wells, pvt-models, etc.) that automatically will be saved (persisted) at the end of a simulation session. This object space also allows lazy-loading of these objects to reduce the in-core memory size, automatic copying (“remoting”) of object to different compute nodes when a simulation is run in parallel mode and easy copying or sharing of objects, when multiple simulation models that coexist in Dynamo use the same data object. An example of a simulation in which Dynamo manages a number of different MoReS models is HFPT, the Hydrocarbon Field Planning Tool, which combines a number of MoReS models with a facilities model in PTNet, and which is described by N. Beliakova et al in SPE paper 65160 “Hydrocarbon Field Planning Tool for medium to long production forecasting from oil and gas field using integrated subsurface-surface models” presented at the SPE European Petroleum Conference held in Paris, France 24-25 Oct. 2000.

Most data in an object space is accessible to the user and can be viewed and manipulated using the embedded scripting interface or the graphical user interface.

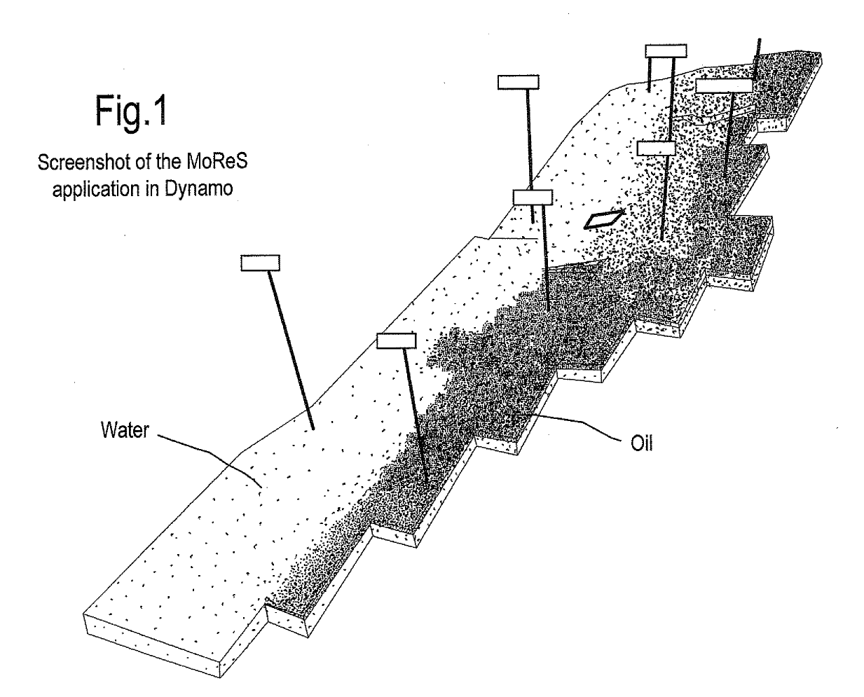

FIG. 1 shows the MoReS application in Dynamo, with a data browser at the left, and a viewing panorama at the right. The data browser at the left allows the user to inspect and modify simulation data, which is organized in folders. Data can be shown in 2D and 3D viewers, in spreadsheets or plain text format. Also scripts in Dynamo Command Language (DCL) can be entered and executed via the GUI. Models are specified using this flexible DCL, which is a mix of key words and programming constructs. For example, the instruction to shut-in all producer wells with a water-cut above 98% looks like:
FOREACH prod IN PROD_LIST DO\
(IF (<prod> BSW GT 0.98) THEN <prod> SHUTIN=ON;)

Since all sub-applications in Dynamo share the same process space, and have a well organized, modular data model, it is simple and efficient to exchange data between applications and to allow, for example, the PTNet application to access or change data with a MoReS model. This feature of the data model layout has been used to extend the simulation platform, with the objective to provide a working environment in which the user can easily manage and control simulation studies that require executing very many simulations. This driver application, which is an integral part of Dynamo, similar to MoReS or Reduce++, has the name “MultiRun”

### B. Embedded Uncertainty for Multi-Run Simulation Studies.

Currently, proprietary and commercial reservoir flow simulators are capable of simulating a reservoir model, with specific input data and boundary conditions. In order to capture the consequences of input data uncertainty on the computed simulation results, it is common practice to perform a large number of simulation runs, with input prescriptions that cover as best as is practical the uncertainty ranges of the input data. Hence, the current uncertainty modelling workflows require the collaboration of two separate software tools: A stand-alone reservoir flow simulator (the worker) and a separate driver tool. The driver tool contains the user-specified description of input data uncertainties and can produce a number of input specifications for the worker run, through “splicing” a template text-based input file for the flow simulator (the template contains tags which the splicing replaces by numerical values). The driver tool then can submit a (large) number of runs according to the method selected for probing the input data uncertainty (using Experimental Design, Markov Chain Monte Carlo or other methods). Finally this driver tool reads results from worker output files and stores and processes these results and presents them to the user. A characteristic feature of this type of workflow is the separation of the required data uncertainty description, which is contained in the driver tool, from the simulation tool that can process this input. Such workflows with separate workers and driver tools have a number of drawbacks:

a) The driver tool does not have the proper context for the (input and output) data, which is available in the dedicated worker tool (e.g. 3D viewers for grid data, dedicated plotting of relperm and PVT data etc.).

b) The template input file typically contains tags (to allow splicing) that prevent such a template input file to be processed directly by the simulation tool.

c) The content of a single simulation model, even when part of an uncertainty workflow, does not contain any information on input data uncertainty.

d) Simulation results are distributed over two separate tools: full detailed results, only for one set of input data, resides in the (many) worker output files; Input uncertainty prescription and post-processing results with estimates of uncertainty ranges reside in (the output of) the driver tool.

e) Data exchange between driver and worker is text based (often ASCII). When large amounts of data have to be transferred (such as sensitivities of well response on permeability changes), this data exchange slows down the workflow.

The Embedded Uncertainty approach implements an alternative data organization and allows implementing uncertainty-managing workflows in a more efficient and coherent fashion. The invention has two sides: and extension of the simulator data model to attach uncertainty to the application input and output data, and an driver tool that is integral part of the simulation system to manage uncertainty workflows. The data uncertainty description is captured in an Object Oriented data structure, which is tightly linked to the data used in the simulation tool. In contrast with the currently available methods, the worker run contains the data uncertainty. This embedded data uncertainty can therefore be used to produce simulation results that reflect the uncertainty of the input data, or it can be inspected and modified in the stand-alone simulation model. This Embedded Uncertainty approach can accommodate all data sampling methods that are currently used for uncertainty estimation and data assimilation, such as Experimental Design, Markov Chain Monte Carlo and ensemble Kalman filter methods. It can also accommodate emerging methods that need direct access the probability distribution of the data, to directly compute the distribution of simulation output results, such as the Moments Methods currently under development in Stanford University. In addition to embedding uncertainty in the data model, also the driver application has been made integral part of the simulation system. This driver is responsible for managing a large number of simulations with different realizations of uncertain input data. In this application the user can specify the sampling method: how many simulation must be done and which data values must be used in the simulations.

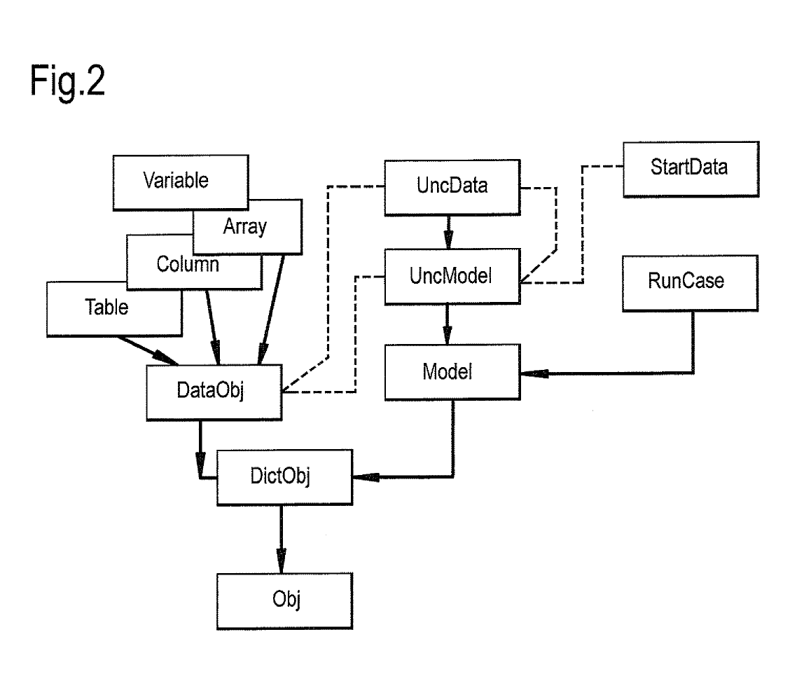

In Dynamo, the extension of the data model with uncertainty has been done in a generic ways, such that al derived applications (upscaling, flow simulation, facility modelling and multi-run manager) inherit this feature to work with data that has linked uncertainties. The user can specify data uncertainty for all basic data containers: scalar variables, (grid property) arrays and tables. This input uncertainty specification can be done using the graphical user interface, or using extensions of the DCL scripting interface. Data uncertainty is associated to data using a bi-directional link between a data object and the object that contains the uncertainty specification, which will be referred to as the uncertainty descriptor (or UncModel in FIG. 2 below). If when data is accessed, it can therefore be checked if this data is uncertain, by inspecting the linked uncertainty descriptor; the reverse link is used, when the uncertainty descriptor is accessed to find (possibly multiple) data objects to which the uncertainty description applies.

The uncertainty descriptor contains functionality and attributes to describe the allowed or expected range of values of the data with an associated relative probability (density) for each value. Since the data object can contain many elements, such as the permeability values for each reservoir model grid block that are contained in a grid property array, a full-detail description of the uncertainty in the data is impractical. Hence, the uncertainty descriptor contains methods and attributes to parameterize the associated data. Such a parameterization describes the allowed ranges of data variations using (typically a much smaller number of) dimensionless parameters. Various simple parameterizations are predefined in the Dynamo uncertainty descriptors. This can be done in a generic fashion, because they are implemented as methods on DataObj, which is the base class for the specific Array, Table and Variable data objects (as illustrated in FIG. 2).

Examples of these default parameterizations are (using a permeability grid array Kₓ and dimensionless parameters pₓ as illustration):

a) Scaling each data element with a fixed reference value (which can be a constant or a container of the same type as K), Kₓ=pₓKₓ^{ref}, this scaling can be linear or logarithmic, Kₓ=e^{p}^{ₓ}Kₓ^{ref};

b) Subdividing the data in an arbitrary number of “regions”, N, using region-projection operators Pₓ^{r}, r=1, . . . , N, with Kₓ=Σᵣp^{r}Pₓ^{r}Kₓ^{ref};

c) Scaling using interpolation between two reference data objects, Kₓ=pₓKₓ^{min}+(1−pₓ)Kₓ^{max}, which can also be combined with a region-projection to reduce the number of parameters.

Parameterization makes it possible to combine different types of data (pressures, flow rates, permeability values etc. which all have different units and dimensionality) in a single set of dimensionless parameters. Since these parameters are detached from all domain-specific details of the data, they can be easily transferred from the worker application (e.g. MoReS, Reduce++ or PTNet) to the driver application MultiRun Since MultiRun only has to handle the real-valued, properly scaled, parameters, it can use generic methods to compute the parameter updates or modifications that are required for uncertainty sampling or optimization.

Some details of the data inheritance and collaboration described above are shown in FIG. 2, which shows a layout of the object oriented data model with extensions to capture data uncertainty based on the Dynamo data model. The yellow and green boxes are basic data classes, the yellow boxes represent basic data containers like Array, Variable, Table and Column They derive from DataObj which implements generic properties like iteration, minimum and maximum allowed values and unit/dimensionality information. The DictObj class is responsible for making the data visible to the user, in the GUI or via the scripting interface. All data derives from Obj, which is responsible for registration in the object space, persisting this data, data replication in parallel mode and copying data from one application to another. The blue boxes are the extension of the data model required to capture uncertainty. The UncModel and UncData contain the uncertainty description. A single uncertainty description must refer to multiple data objects in order to describe correlation between these two data objects in the uncertainty distribution. The properties of a single data object, such as minimum and maximum allowed values, reference values for scaling, etc. are managed by the UncData class. The UncModel can refer to multiple UncData instances and contains the combined uncertainty description and data parameterization. The RunCase is a data object that is used to specify values for a collection of uncertain data (data objects linked to an UncModel). It is initialised in the driver application and automatically copied from the driver object space to the worker object space, which then uses it to instantiate its uncertain input data. A RunCase contains a specific value, or an instruction to compute the value for each of the uncertain data in the worker. The instruction can for instance be to draw a random value according to the probability distribution assigned to that data, or to use the minimum/average/maximum value. The StatData is a helper class that is responsible for computing statistical properties of data (average, standard deviation, error bars etc.).

After extending a model description, the input deck, with uncertainty descriptions for one or more input data, this deck can still be processed as a stand-alone simulation. In that case the linked uncertainty description is simply ignored and the default or reference value is used for the data. The results of such a single simulation will, of course, not show uncertainty in output results, but the user can still inspect the uncertainty of the input data, and easily specify in the input deck that different values from the various uncertainty ranges must be used. Alternatively such an input deck with uncertainty descriptors can be executed by the driver application in the simulation system. If this is the case, the user can specify in detail, which values to use for each uncertain data object in the worker run. This is done by defining a number of RunCases, which amounts to supplying values in a schedule table in which each column represents an uncertain data object and each row a simulation run case; or specifying an instruction for the worker how to compute the data (random draw, minimum/average/maximum value etc.) in each row of the schedule. The information from each of these rows of this schedule comprises a RunCase and will be (internally) transferred to the worker simulations. Of course these worker simulations can be executed sequentially on a single machine, or concurrently if suitable hardware is available. At the end of a worker simulation, pre-selected output results are automatically transferred to the drive and are post-processed to show uncertainty ranges to the user. The user can specify any data object present in the worker (table, variable or array) to be returned as output, by adding the name of the data object to the so-called output-table in MultiRun. Since all data resides in the integrated simulation system (in different object spaces in Dynamo) such data transfer between worker applications and driver is very fast and does not require file based I/O. After completing simulation of all cases, the output is automatically gathered in a single summary case. This summary case can be used to inspect the resulting uncertainty of the simulation results. The output is automatically post-processed for easy visualisation, and the multiple output data is (also) presented as output data with an uncertainty descriptor, such that all visualization options and statistical analysis that are available for data with an uncertainty descriptor can also be used for output data as well as for input data.

C. A Simple Uncertainty Scouting Workflow to Illustrate the Usage of Embedded Uncertainty Modelling a Simple Workflow that Uses Monte Carlo (MC) Sampling of Uncertainties of Rock Properties in a Layer-Cake Green Field is Described Below.

The reservoir consists of a large number of layers, with uniform permeability, with values that are log-normally distributed around an estimated average value for each layer. Similarly, the layer thickness is uncertain, with a triangle-shaped probability distribution. The objective is to assess the effectiveness of a water flood using injectors that are completed in all layers.

Setting up and executing a MC sampling workflow for this study proceeds along the following steps:

a) Build a simulation model for a model with base-case permeabilities and layer thicknesses.

b) Define uncertainty descriptors for the permeability array and for the array with layer thicknesses. As parameterization, a regions-based logarithmic scaling of the permeabilities is selected, using the base-case permeability as reference values and where each layer is a parameter region. For the layer thickness array a direct value substitution in units of “meter” is selected (i.e. the parameters value are the layer thickness in meters). For the permeability parameters a normal distribution is specified, with input average value and standard deviation per regions (layer). For the thicknesses parameters a triangle probability distribution is specified: the minimum, maximum and top-values of the triangle are provided as input for each region.

c) Load the model to check that the proper uncertainty ranges have been specified. No full simulation is required, just the initialization stage, after which the linked uncertainty prescriptions can be inspected (making plots of the PDFs for the permeabilities, for example, or selecting some other values from the uncertainty ranges).

d) Create a driver project (MultiRun input deck) that specifies how the uncertain data in the worker model must be sampled. In this case the user must select the Monte Carlo method and specify the number of sampling runs. Besides a number of default data (such as well and field production data), the user can specify additional data that should be collected from the worker runs. Any data object can be selected by simply adding its name to list.

e) Execute the uncertainty workflow. For this type of Monte Carlo sampling, the task of the driver is simple: the requested number of jobs are executed, each with the instruction to draw an unbiased realization from the PDF for its uncertain data (permeability and layer thickness). Since these data uncertainties are contained in the worker, all information is available for such a random draw. If the simulation system is running in parallel mode on a cluster, the worker runs will be executed concurrently on different machines. All data transfer is though inter-process data copy operations—no file I/O is involved.

Inspect the collective simulation results. After completing all worker runs, the driver creates a dedicated “summary run”, which is based on the (first or reference) worker run. The requested output from all worker runs is copied to this summary run, in suitable data containers, such that the user can inspect and analyze the results using the full capabilities of the simulation application. Where appropriate, the results are automatically post-processed, e.g. to compute averages and standard deviations.

The main result of this specific study is the distribution of cumulative oil production after injecting one pore volume of water. The summary run also contains combined data for the saturations and pressures of all individual simulations.

### D. Conclusions

The foregoing detailed description of a preferred embodiment of the method and system according to the present invention shows the advantages of using an integrated simulation system with embedded uncertainty modelling.

The uncertainty is integral part of the data description and can be defined and inspected in the proper context of the (flow simulation, upscaling or surface facility) worker model.

All model specifications, both for the individual models and the uncertainties are managed and saved together, which improves auditability.

In an integrated system, the workflow can extend from static modelling, through upscaling and flow simulation to facility modelling, in a uniform fashion.

A worker model with uncertainty prescriptions for some of the data, can be run in an uncertainty workflow or stand-alone, unlike template input decks with tags that cannot be run as a stand-alone deck without removing the tags.

The foregoing detailed description of preferred embodiments has focused on uncertainty workflows. However, also lifecycle optimization workflows, with adjoint-based gradients or gradients computed via streamline techniques and using home-grown or off-the-shelf optimization algorithms, naturally fit in this architecture, as described by J. Kraaijevanger et al in SPE paper 105764 “Optimal Waterflood Design Using the Adjoint Method” presented at the SPE Reservoir Simulation Symposium, Houston, USA, 26-28 Feb. 2007 and by Milliken, W. J. et al. in SPE paper 63155 “Application of 3-D Streamline Simulation to Assist History Matching,” presented at the 2000 SPE Annual Technical conference and Exhibition, Dallas, 1-4 October.

Using data parameterization, virtually any optimization and uncertainty sampling algorithm can be implemented easily, because the details of the data are hidden behind the parameterization and the algorithms are exposed only to real-valued parameters. Also external optimization or sampling software can be easily plugged-in.

In contrast to deploying multiple tools that need to collaborate, the deployment of embedded uncertainty managing workflows is as easy as the deployment of the single simulation system by itself.

Data exchange between driver and worker is maximally efficient without the need for file-based I/O.

It will be understood that both simple green-field uncertainty scouting and field-scale data assimilation methods can easily be accommodated in the embedded uncertainty approach according to the invention.

It will be understood that the embedded uncertainty approach according to the invention can, besides in embedded uncertainty workflows in the simulation program Dynamo also be implemented in other, conventional and/or next-generation, reservoir simulation systems

What is claimed is:

1. A method for simulating fluid flow in an underground reservoir formation with uncertain properties, the method comprising:
a) building an object oriented reservoir simulation model with embedded uncertainty descriptors that identify a range of estimated values of each of the uncertain properties;
b) using the uncertainty descriptors to define probability distributions and parameterizations for data objects associated with the uncertain properties;
c) providing each uncertainty descriptor with functionality to display a probability distribution to an associated parameterized data object in a graphical user interface of a reservoir flow simulator; and
d) processing the reservoir simulation model in the reservoir flow simulator such that the graphical user interface displays user selected uncertainty descriptors, parameterized data objects and resulting spread of reservoir flow simulation results.

2. The method of claim 1, wherein the graphical user interface offers a user the opportunity to display a single realization of several uncertain parameterized data objects to perform a flow simulation and the method further comprises the steps of:
e) executing the model that is extended with one or more uncertainty descriptors for one or more data objects by a dedicated workflow manager, which is an integral part of the flow simulation model, which manager offers the user the opportunity to select multiple methods to sample the data object uncertainty, for example Monte Carlo methods, Experimental Design, Ensemble Kalman filter methods and/or statistical methods;
f) transferring data objects between the workflow manager and a worker application using one or more direct copy methods within a process space of the reservoir flow simulator;
g) specifying a statistical method for sampling uncertain permeability and layer thickness data objects in the flow simulator; and
h) simulating fluid flow in the flow simulator using a work flow in which steps (a)-(g) are executed.

3. The method of claim 1 wherein in the parameterization according to step b) a simplified functional relation between parameterized uncertain data and uncertain properties is specified.

4. The method of claim 3 wherein in the parameterization according to step b) the uncertainties of the data objects are described in a simplified way, using fewer degrees of freedom than in the associated uncertain properties; and the parameterization includes:
providing different types of scaling of reference input data and/or interpolation between two or more reference input data;
using a single parameter to scale or interpolate a set of input data values, such as parameterization of permeabilities;
using a regions based logarithmic scaling of the permeabilities, wherein a base-case permeability is used as a reference value and each formation layer is a parameter region.

5. The method of claim 4 wherein the method further comprises displaying the uncertainty of the base case permeability and thickness and/or any other input data and/or for displaying the resulting spread of the simulated fluid flow and/or any other output data.

6. The method of claim 1 wherein the uncertainty descriptors and/or spread of the simulated fluid flow and/or any other output data resulting from uncertainty of input data are displayed with error bars, using a post-processing native to a worker tool.

7. The method of claim 1 wherein each uncertainty descriptor is linked simultaneously to at least two input data objects, such that correlations between input data distributions are defined and each uncertainty descriptor is furthermore provided with functionality to perform a statistical analysis of the data objects, such as computing averages, standard deviations, higher moments and covariances; and wherein in step (b) the probability distribution is defined by:
specifying a normal distribution for the permeability and/or other property parameters;
defining input average value and standard deviation per formation layer and/or triangle and block shaped distributions, both for the data values and for the logarithm of the data values; and/or
if the data is discrete/categorical data, providing a list with equally probable or weighted data values in the uncertainty descriptor.

8. The method of claim 7 wherein the method further comprises a statistical analysis of the input and output data ranges, including determination of average values, standard deviations, higher moments and/or histograms.

9. The method of claim 1 wherein the method is used for simulating hydrocarbon, water and/or other fluid flow in an at least partly porous underground earth formation with uncertain structural and physical properties, such as volume, thickness, permeability, porosity, layering and/or fracturing, wherein the embedded uncertainty descriptors are linked to available input data, such as property tables, columns, grid property array and/or scalar model variables and the method further comprises an upscaling application, which transforms a geo-cellular grid to a less-detailed grid suitable for flow simulation.

10. The method of claim 1 wherein the flow simulation method is combined with a facilities network simulation method, such that uncertainties can be investigated in an integrated flow simulation model in which subsurface flow through a hydrocarbon fluid containing earth formation is coupled to flow through an hydrocarbon fluid gas production facilities network.

11. The method of claim 1 wherein the method is used to plan, simulate, monitor, execute and/or manage hydrocarbon fluid operations from a hydrocarbon fluid containing reservoir formation and/or to plan, simulate, monitor, execute and/or fluid injection operations for stimulating production of hydrocarbon fluids from a hydrocarbon fluid containing formation.

12. The method of claim 1, further comprising the step automatically post-processing the output data to capture multiple simulation results into uncertainty descriptors for the output data.

13. A system for simulating fluid flow in an underground formation comprising a number of hydrocarbon fluid containing layers with uncertain thicknesses, volumes, permeabilities and/or other physical properties, the system comprising:
a) a simulation model for the formation, which model represents the formation as a number of hydrocarbon fluid layers with predetermined base-case permeabilities, volumes, thicknesses and/or other physical properties;
b) means for defining uncertainty descriptors for the uncertain properties;
c) means for specifying a statistical method for sampling the uncertain properties in the simulation model; and
d) display means for displaying the uncertainty descriptors and associated spread of reservoir fluid flow simulation results in the simulation model.

14. The system of claim 13 wherein the display means comprises means for displaying the uncertainty of the base case permeability and thickness and/or any other input data and/or for displaying the resulting spread of the simulated fluid flow and/or any other output data.

15. The system of claim 13 wherein the display means comprise error bars for displaying the uncertainty descriptors and/or any spread of the simulated fluid flow and/or any other output resulting from uncertain input data, using a post-processing native to a worker tool.
